(19) United States
(12) Patent Application Publication
(10) Pub. No.: US 2015/0017314 A1
(43) Pub. Date: Jan. 15, 2015

(54) COLD BATTER MINCING OF MEAT THROUGH HOT-BONED AND CRUST-FREEZING PROCESSES

(71) Applicant: Board of Trustees of Michigan State University, East Lansing, MI (US)

(72) Inventors: Iksoon Kang, Okemos, MI (US); Gale Strasburg, East Lansing, MI (US); Bradley P. Marks, Haslett, MI (US)

(21) Appl. No.: 14/326,853

(22) Filed: Jul. 9, 2014

Related U.S. Application Data
(60) Provisional application No. 61/844,285, filed on Jul. 9, 2013.

(51) Int. Cl. A23L 1/317; A23L 1/314

(52) U.S. Cl. CPC A23L 1/3177; A23L 1/31463; A23V 2002/00
USPC 426/645

(57) ABSTRACT

Some embodiments of the disclosure are directed to a method of preparing meat. The method comprises the steps of: separating a meat segment from a carcass when the carcass has a temperature within five degrees Celsius (5° C.) of live body temperature; reducing the size of the meat segment into a plurality of meat segments; crust-freezing the meat segments; and combining the crust-frozen meat segments with water, ice, and salt, at a temperature within five degrees Celsius (5° C.) of freezing to form a batter.

### CROSS REFERENCE TO RELATED APPLICATIONS

This application claims the benefit of U.S. Provisional Application No. 61/844,285 titled COLD-BATTER MINCING OF HOT-BONED/CRUST-FREEZING AIR CHILLED TURKEY BREAST IMPROVED MEAT TURNOVER TIME AND PRODUCT QUALITY, filed on Jul. 9, 2013 (Docket #063000.00092), the entirety of which is incorporated herein by reference in various non-limiting embodiments.

### TECHNICAL FIELD

The present disclosure relates to methods of meat preparation and, more particularly, to particular methods of meat preparation using hot-boning and cold-batter-mincing techniques.

### BACKGROUND OF THE DISCLOSURE

Standard practices of separating and processing meat products regularly involve the chilling of carcasses prior to processing of chilled, deboned muscles. This process, known as chill-boning, is a common method that allows for extended processing of meats from slaughter to packaging for sale. Unfortunately, chill-boning also leads to a reduction of meat quality due to the onset of rigor mortis within the deboned meat. Such loss in quality is noted in lowered pH of the raw meat and measurable cooking loss in the processed meat.

Further processing of meats is common in the industry to generate value-added products such as sausages, deli-style meats, or poultry-based bacons. These products require processing of meats into batters based on a combination of meat segments, water, ice, salt, and spices. Traditional methods mince and blend these ingredients and then use the batter to prepare the above mentioned product types. Unfortunately, due to the longer carcass-chilling time and the subsequent stiffening of muscles after the chilling, processing efficiency is lower and higher salt is required for batter production. In addition, an increase in temperature during batter mixing limits the extension of mixing or protein extraction due to protein denaturation. Accordingly, there remains an opportunity to develop an improved method.

### SUMMARY OF THE DISCLOSURE

The disclosure is generally directed towards processes for both raw meat preparation using hot-boning and crust-freezing methods along with batter-like preparations using hot-boning, crust-freezing, and cold-batter mincing techniques.

One embodiment of the present disclosure is directed to a method of preparing raw meat. The method comprises the steps of: separating a meat segment from a carcass when the carcass has a temperature within five degrees Celsius (5° C.) of live body temperature; reducing the size of the meat segment into a plurality of meat segments; crust-freezing the meat segments; and combining the crust-frozen meat segments with water, ice, and salt, at a temperature within five degrees Celsius (5° C.) of freezing to form a batter.

Another embodiment of the present disclosure is directed to a batter. The batter comprises meat, water, ice, and salt. The batter is prepared by: separating a meat segment from a carcass when the carcass has a temperature within five degrees Celsius (5° C.) of live body temperature; reducing the size of the meat segment into a plurality of meat segments; crust-freezing the meat segments; and combining the crust-frozen meat segments with water, ice, and salt, at a temperature within five degrees Celsius (5° C.) of freezing to form a batter.

### BRIEF DESCRIPTION OF THE DRAWINGS

Other advantages in the present disclosure will be readily appreciated as the same becomes better understood by reference to the following detailed description when considered in connection with the accompanying drawings:

FIG. 1 is a representative flowchart of one embodiment of the method;

FIG. 2 is a representative flowchart of an alternate embodiment of the method; and

FIG. 3 is a table illustrating comparative measurements between traditional processing methods and the method described herein;

FIG. 4 is another table illustrating comparative measurements between traditional processing methods and the method described herein;

FIG. 5 is another table illustrating comparative measurements between traditional processing methods and the method described herein;

FIG. 6 is a graph illustrating comparative measurements between traditional processing methods and the method described herein;

FIG. 7 is another graph illustrating comparative measurements between traditional processing methods and the method described herein;

FIG. 8 is another graph illustrating comparative measurements between traditional processing methods and the method described herein; and

FIG. 9 is another graph illustrating comparative measurements between traditional processing methods and the method described herein.

Corresponding reference characters indicate corresponding parts throughout the drawings.

### DETAILED DESCRIPTION OF THE DISCLOSURE

A selected embodiment of the present disclosure will now be described with reference to the drawings. It will be apparent to those skilled in the art from this disclosure that the following description of the embodiments of the present disclosure is provided for illustration only and not for the purpose of limiting the disclosure as defined by the appended claims and their equivalents. Unless other noted, all percentages and ratios are by weight. All references are expressly incorporated herein by reference in various non-limiting embodiments.

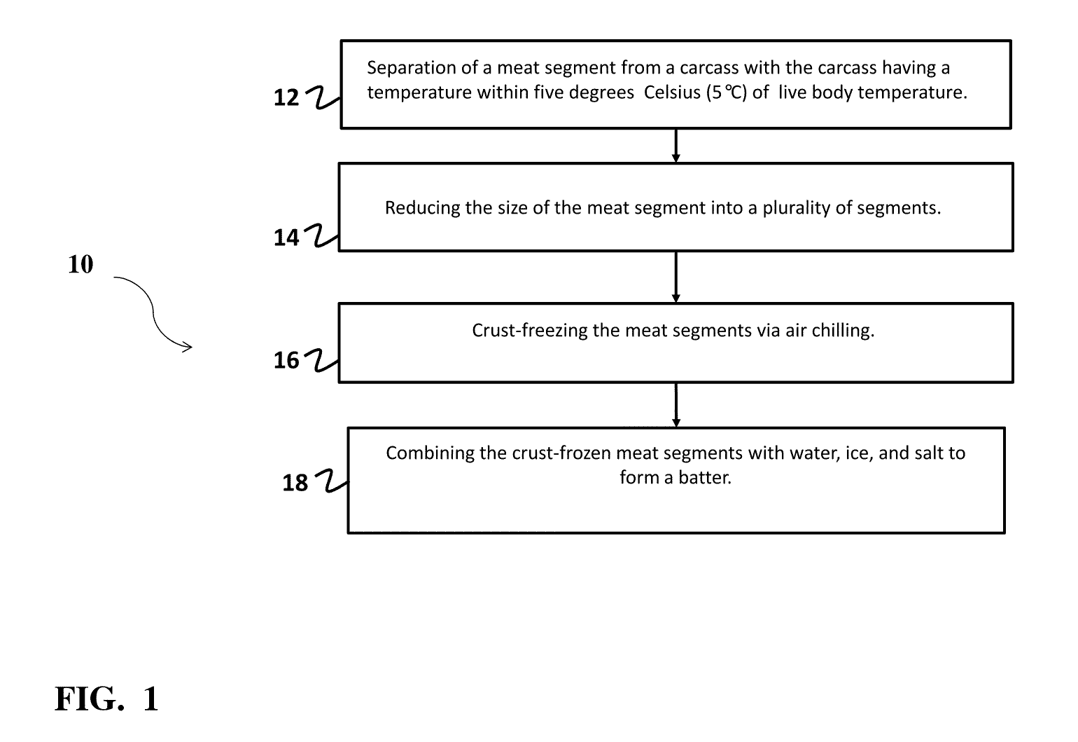

The method in FIG. 1 describes a method 10 of meat preparation through the use of hot-boning and crust-chilling techniques. Within this description, the meat referenced as an example is turkey. Poultry that may be used in this method includes turkey, duck, goose and the like. Other forms of livestock may also be used, including beef, pork, goat, sheep, fish, etc.

First, the method 10 begins by separating 12 a meat segment 02 from a carcass 04. This separation is typically done through a method known as hot-boning. Hot-boning is defined as the separation of meat flesh from a carcass when the animal is recently slaughtered and the carcass remains near live body temperature. This ensures the pre-rigor mortis condition of the meat and retains more of the quality of the meat during processing. This hot-boning technique can occur within 5 degrees of the live body temperature (where the carcass may be temporarily warmer than the live body temperature due to lack of blood circulation dissipating the carcass heat) but should occur at no less than five degrees Celsius (5° C.) below the live body temperature. As an illustrative, non-limiting example, live body temperature for a turkey carcass is about forty degrees Celsius (40° C.). Hot-boning temperatures for other types of livestock are typically based on their commonly known live body temperatures, as appreciated by one of skill in the art.

Next, the meat segment 02 is reduced 14 in size into a plurality of smaller meat segments 02. This step ensures that the crust freezing step 16 occurs in a consistent manner for all the meat segments that are processed by the method. As an illustrative example for a turkey breast meat segment the ideal reduction in size will produce small segments between 4 to 6 centimeters on any one side of the smaller meat segment 02. This reduced size can vary depending on the particular type of crust-freezing that occurs as well as the type of meat that is being processed.

Next, the plurality of meat segments 02 are crust-frozen 16 prior to mixing or other further processing (i.e. pickle injection). Crust-freezing, also known as rapid-chilling, has the main purpose of not completely freezing the meat segment. All that is required is that the center of the meat segment 02 remains four degrees Celsius (4° C.) or below. The outside temperature of the meat segment 02 may be close or at freezing. This type of freezing is utilized to ensure that the meat segment 02 maintains the temperature below four degrees Celsius (4° C.). While minimizing muscle contraction due to rigor mortis of the meat segment 02. the range of temperature for crust-freezing to occur is usually from minus five (−5° C.) to minus fifty (−50° C.) degrees Celsius and can average from 1 to 150 minutes in order for the meat segments to reach the four degrees Celsius (4° C.) core temperature.

In one embodiment of the disclosure, the crust-freezing performed at step 16 is done by air-chilling. Air-chilling typically requires the use of cold air over the meat segments 02 in order to reduce the muscle temperature. The rate of air flow can vary from half a meter per second (0.5 m/s) to six meters per second (6 m/s), depending on the logistical needs of meat processing facility.

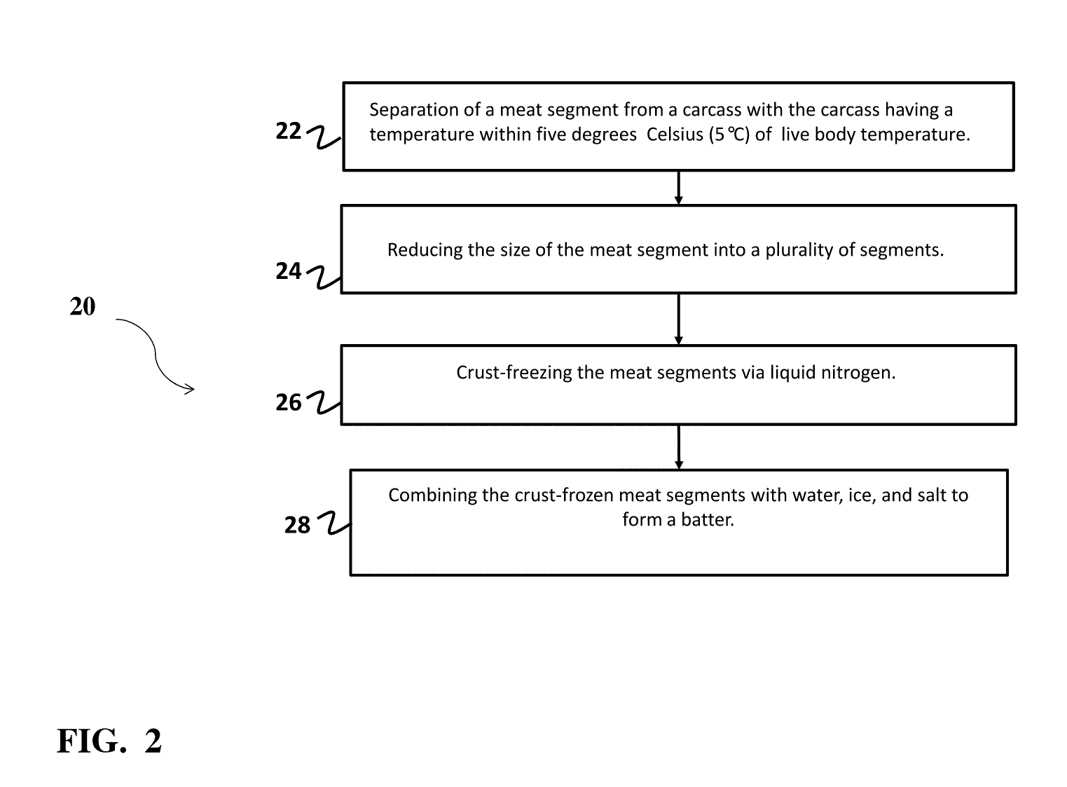

In another embodiment of the present disclosure, e.g., as illustrated in FIG. 2, the crust-freezing step 16 described above is replaced by an alternate crust-freezing step 26. This step 26 typically utilizes liquid nitrogen in order to crust-freeze the meat segment 02 to the necessary core temperature below four degrees Celsius (4° C.). The meat segments 02 may be dipped in liquid nitrogen, but the liquid nitrogen may also be sprayed on in order to generate the chilling of the meat segment 02.

Finally, the frozen plurality of meat segments 02 are combined 18 with water, ice, and salt in order to form a batter 05. The combination into the batter 05 may occur by mincing of the all the identified components, but the process is not limited to that method alone. The combination occurs within five degrees Celsius (5° C.) of freezing. This is known as “cold-batch” processing. Once combined then the batter is then utilized for continued processing into meat-based food products.

In some embodiments, the amount of crust-frozen meat segments 02 in the batter 05 is from twenty percent (20%) to ninety percent (90%) by weight. This variation of the percentage amount of crust-frozen meat segments 02 will depend on the required consistency of the batter, which may depend on the meat product being produced and the manner of processing (mincing, etc.) used in cold-batch processing.

In some embodiments, the amount of water in the batter is from zero point one percent (0.1%) to four percent (4%) by weight. Also, in some embodiments the amount of ice in the batter is from five percent (5%) to forty percent (40%) by weight. Variations on the amounts of water and ice are dependent on the required consistency of the batter 05 required for final processing.

In some embodiments, the salt present in the batter is from point five percent (0.5%) to five percent (5%) sodium chloride by weight. The aim of this measure of salt is that within an ideal environment, the cold batch processing reduces the overall need for additional salt to below two percent (2%) sodium chloride by weight.

Ultimately, the methods 10 and 20 generate a batter 05 which retains more of the protein functionality of the meat segments 02 than through processing by traditional methods. This is demonstrated through a higher pH value (which is favored as lowered pH indicates the development of rigor mortis or muscle stiffness) and lower R-values (R-values defined as the ratio of inosine to adenosine nucleotide within the protein tissue of the meat segment, discussed in further detail below).

### Examples

In one example of the method within the present disclosure, for each of 3 replications, 15 turkeys were slaughtered and eviscerated. Three of the eviscerated carcasses were randomly assigned to water-immersion chilling (WIC) for chill-boning (CB) and the remaining were immediately hot-boned (HB), half of which were used without chilling whereas the remaining were subjected to crust-freezing air chilling (CFAC) in an air-freezing room (1.0 m/s, −12° C.) with/without quarter sectioning (HB-CFAC, HB-¼CFAC). As a result, CB and HB breasts were minced using 1 of 5 treatments: (1) CB and traditional mincing (CB-T), (2) HB and mincing with no chilling (HB-NC), (3) HB and mincing with CO₂ (HB-CO₂), (4) HB and mincing after CFAC (HB-CFAC), and (5) HB and mincing after quarter sectioning and CFAC (HB-¼CFAC). Traditional water-immersion chilling took an average of 5.5 h to reduce the breast temperature to 4° C., whereas HB-CFAC and HB-¼CFAC took 1.5 and 1 h, respectively. The breast of HB-CFAC and HB-¼CFAC showed significantly higher pH (6.0-6.1), higher fragmentation index (196-198), and lower R-value (1.0-1.1; P<0.05) than those of the CB controls. No significant differences (P>0.05) in sarcomere length were seen between CB-T and HB-CFAC filets regardless of quarter sectioning. When muscle was minced, the batter pH (5.9) of CB-T was significantly lower (P<0.05) than those (6.1-6.3) of HB-NC, HB-CO₂, and HB-¼CFAC, with the intermediate pH (6.0) seen for the HB-CFAC. When meat batters were cooked, higher cooking yield (90-91%; P<0.05) was found in HB-CFAC, HB-¼CFAC, and HB-CO₂, followed by HB-NC (90%) and finally CB-T (86%). Stress values (47-51 kPa) of HB-CFAC gels were significantly higher (P<0.05) than those of CB-T (30 kPa) and HB-NC (36 kPa). A similar trend was found in strain values.

The average carcass temperature after evisceration was 40.5° C., which continuously decreased in ice slurry chilling to 4° C. with a regular average chilling time of 5.5 h (approximately 0.2° C.). When breasts were HB and chilled in the air-freezing room (1 m/s, −12° C.), the average chilling times were 1 and 1.5 h, respectively, for the HB-CFAC filets with or without quarter sectioning. One of major advantages of air chilling is the temperature adjustment to the levels of water chilling or lower by varying the air temperature and/or speed.

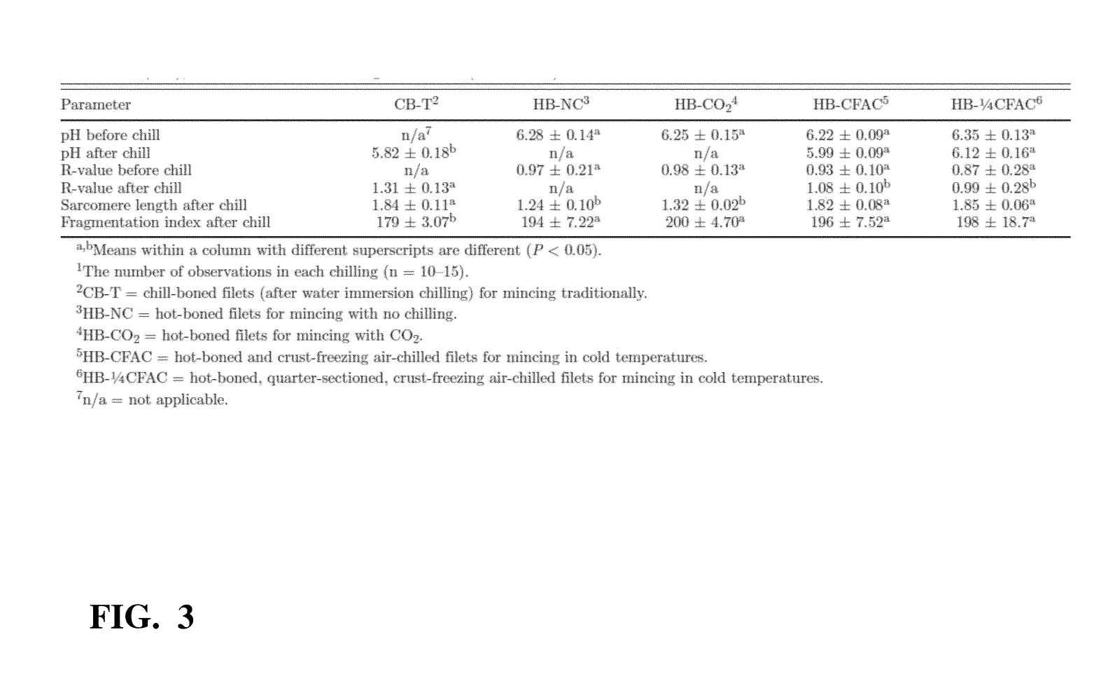

Turkey breast pH ranged from 6.28 to 6.35 immediately after HB (FIG. 3), indicating that they are normal (pH>6.0 at 15 min postmortem) rather than rapid glycolyzing breasts (pH<5.80). After 5.5 h of WIC, the breast pH decreased to 5.82, which was significantly lower (P<0.05) than those of 1.5-h HB-CFAC (5.99) and 1-h HB-CFAC (6.12; FIG. 3). Owens et al. (2000) indicated that the breast pH (6.09) of normal turkey (47 L*) was higher than that (5.72) of pale turkey (56.9 L*) at 1.5 h postmortem. The combination of rapid early pH decline (0.5-1 h) and high body temperature (˜37° C.) is detrimental to protein functionality (water-holding capacity and texture cohesiveness) and visual appearance. The R-value (the ratio of inosine:adenosine-containing compounds) of HB breasts ranged from 0.87 to 0.93 (FIG. 3). After CFAC, the value increased to 0.99 to 1.08, which is significantly lower (P<0.05) than that (1.31) of WIC filets, indicating that ATP was less depleted in the air-chilled breasts at −12° C. (FIG. 3). In accordance with our results, Owens and Sams (1997) reported that the R-value of turkey breasts after 2 h of WIC was 0.94, which increased to 1.11 and 1.21, respectively, at 8 and 24 h postmortem.

Sarcomere length is an indicator of muscle contraction that is correlated with muscle tenderness (Locker, 1960). The sarcomere lengths (1.24-1.32 μm) of HB and CAFC muscles were significantly lower (P<0.05) than those (1.8-1.84 μm) of CFAC and WIC, which were not different from each other (FIG. 3). Muscles of high ATP or low R-value are likely to be shortened during chilling due to the high energy requirements for muscle contraction. It is also known that bone-attached muscles are less shortened than deboned muscles before rigor mortis development. The rapid air-chilling at −12° C. was reported to induce cold shortening in broiler carcasses with pH values ≧6.70 at 15 min postmortem, although shear force value of the carcass was 1.00 kg/cm⁻² lower than those chilled in air at 0° C.

Fragmentation index (FI) is inversely related with the level of muscle aging or protein degradation rather than physical tearing of muscle fibers. The FI (178.6) of CB filets was significantly lower than the FI (193.5-200) of HB filets, regardless of CFAC (FIG. 3). The low value is expected from the aging that occurred during 5.5 h of WIC, whereas the HB and HB-CFAC filets had almost no or shorter aging times, respectively.

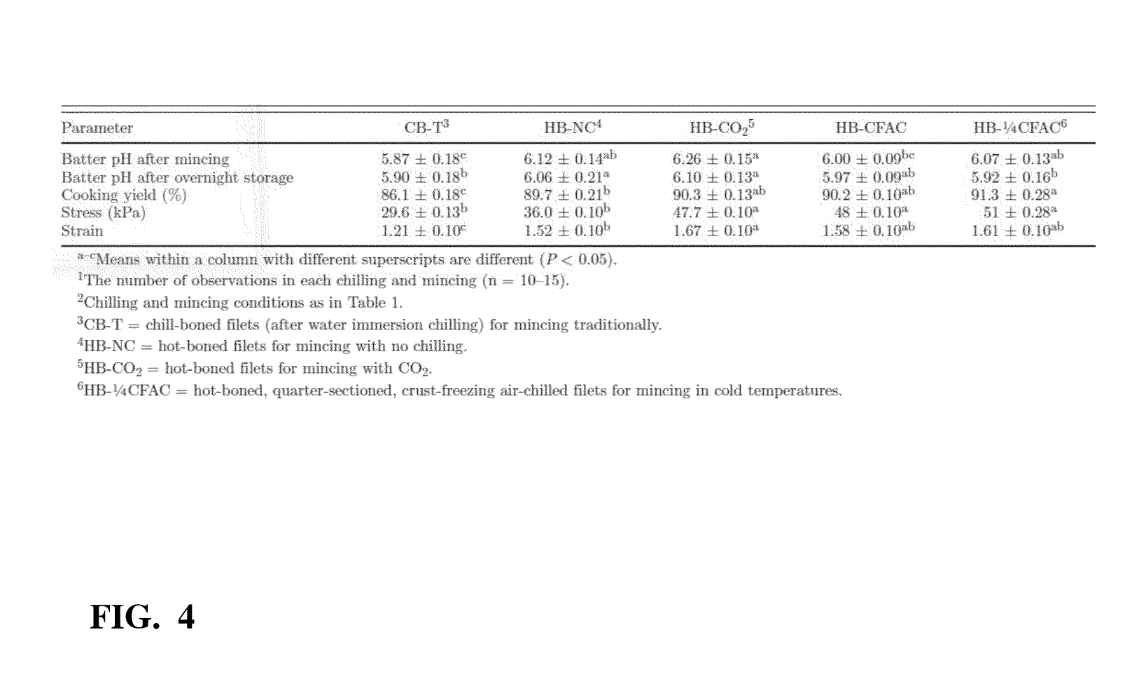

During batter mincing for 7 min, the initial temperature (2° C.) of CB filets gradually increased to 10° C., whereas the initial temperature (−2.5° C.) of HB-CFAC filets remained similar (−2.0° C.) regardless of quarter sectioning. In HB filets, the filet temperature (40° C.) significantly reduced during mincing, to −2.0 and 25° C. with and without CO₂ addition, respectively. Upon the completion of batter mincing, the pH (5.87) of CB-T batter was lower (P<0.05) than those (6.07-6.26) of HB-NC, HB-CO₂, and HB-.¼CFAC, with the intermediate pH (6.0) seen for HB-CFAC (FIG. 4). When the minced batters were stored at 4° C. overnight, the pH (5.90-5.92) of CB-T and HB-¼CFAC were lower (P<0.05) than those (6.06-6.10) of HB-WC and HB-CO₂, with the intermediate pH (5.97) seen for HB-CFAC (FIG. 4).

When the batters were cooked, the cooking yield was increased in a step-wise manner from 86.1% in CB-T to 89.7% in HB-WC, and to 90.2 to 91.3% in the rest of the HB filets (FIG. 4). The property of cooked gels was assessed using a torsion test, in which the failure shear stress (a measure of gel strength) and the true shear strain (a measure of gel deformability) are correlated with sensory hardness and cohesiveness, respectively. The stress values (47.7-50.9 kPa) of HB and chilled meat gels (HB-CO₂, HB-CFAC, and HB-¼CFAC) were greater (P<0.05) than those (29.6-36.0 kPa) of CB or HB and HB-NC meat gels (FIG. 4). Similarly, the strain values (1.58-1.67) of HB and chilled meat gels were higher than that (1.21) of the CB control, with the intermediate (1.52) seen for the HB nonchilled (FIG. 4). The results of indicate that the combination of HB and crust-freezing air chill on turkey breast provides various advantages, such as an accelerated HB process, rapid meat turn-over, high-quality meat, high cooking yield, and superior protein functionality.

Based on the results presented in this illustrative example, the combination of cold-mincing and crust-freezing air chill is a viable processing method for the purposes of superior quality meats at any time and any place, improved protein functionality, sodium reduction, PSE prevention, cure penetration and distribution, and cost savings.

In another example of the present disclosure, in each of 4 visits, 36 Nicholas tom turkeys (approximately 16 weeks-old, ˜18 kg turkey in live weight) were obtained locally and processed in 4 different days. The birds were electrically stunned for 3 s (80 mA, 60 Hz, 110 V) and bled for 90 s by severing both carotid artery and jugular vein on one side of the neck. The turkeys were then scalded (59° C., 120 s), mechanically defeathered (25 s), and manually eviscerated. At about 15 min post-mortem, all carcasses were weighed and core temperatures were recorded from the center of breast using a digital thermometer/logger.

Following the temperature check, half of the carcasses were randomly subjected to an ice/water slurry tank (0.5° C.) for WIC with mechanical agitation until the internal breast temperature reaches 4° C., which took about 5.5 h. The remaining carcasses were subjected to HB-¼CFAC in an air freezing room (−12° C.). Briefly, breast fillets were hot-boned at 15 min PM, cut into quarter portions, and hung by hooks on a stainless steel rack. The resulting fillets were exposed to a continuous air flow (1.0 m/s) until the internal temperature reached 4° C., which took about 1 h. Immediately after chilling, the crust-frozen breasts were chopped for a cold batter mincing (using ice for all batch water), whereas the chill-boned breasts from WIC were chopped in a traditional method (using 20% ice/80% water for batch water) in the following day.

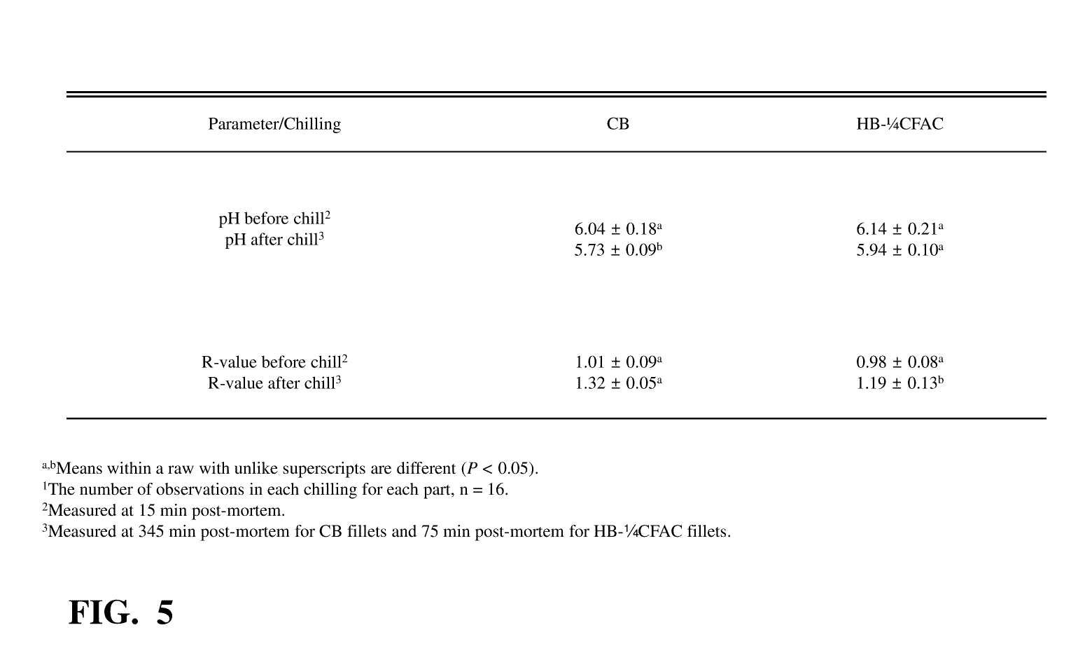

The initial temperature (41.3° C.) of eviscerated turkey carcasses continuously decreased to 4° C., with the average chilling times of 5.5 and 1 h for the carcasses of WIC and HB-¼CFAC. Before chilling, no significant differences were found for pH (6.04-6.14) and R-values (0.98-1.01) in the carcasses fillets assigned for HB and CB (FIG. 5). After hot or chill boning, HB-¼CFAC fillets had higher pH (5.94) and lower R-value (1.19) (P<0.05) than those (pH 5.73, R-value 1.32) of CB fillets (FIG. 5), indicating that less glucose and ATP have been hydrolyzed in the HB-¼CFAC fillets, primarily due to a shorter PM time (15 min) than that (345 min) of CB fillets.

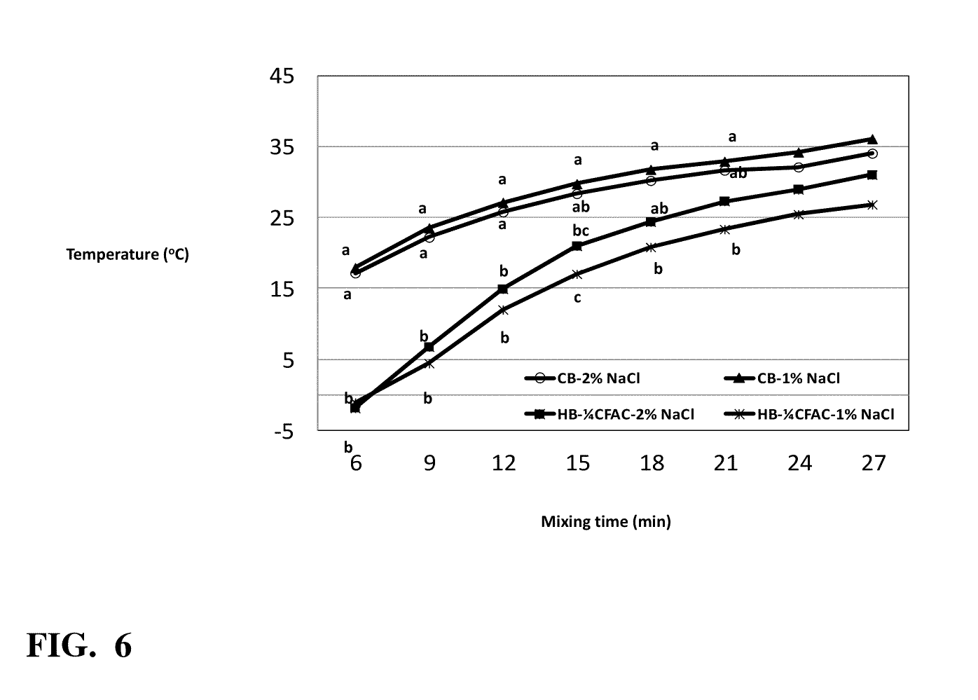

After chilling, breast fillets were minced with 1 or 2% salt for batter preparation. For cold-batter mincing, HB-¼CFAC fillets (surface temperature at −1.5 to −3.5° C.) were minced with 2% salt/20% ice or 1% salt/21% ice, whereas CB fillets (surface temperature at ˜0.5° C.) were traditionally minced with 2% salt/4% ice/16% water or 1% salt/4% ice/17% water. During mincing, the temperatures of traditional-minced batter sharply increased to 17-18° C. at 6 min, whereas those of cold-mincing batter remained at less than −1° C. (FIG. 6). After 6 min, the temperature of cold-minced batter started to increase and resulted in no significant difference (P>0.05) from the traditionally-minced batters at 15 min for 2% salt and 24 min for 1% salt (FIG. 6).

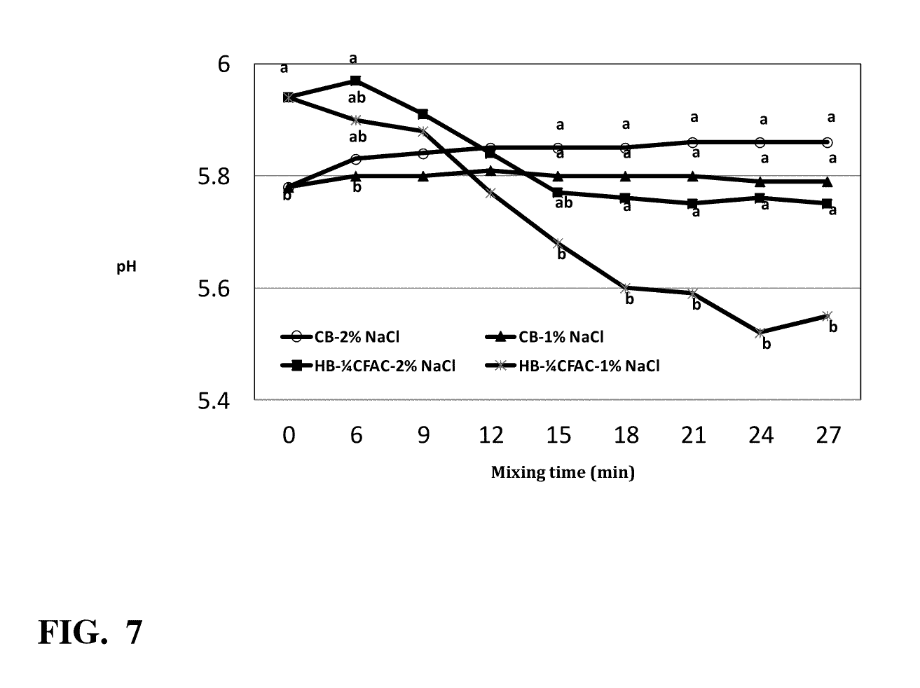

At 6 min mincing, the pH (5.97) of 2% salt HB-¼CFAC batter was higher (P<0.05) than that (pH 5.82) of 1% salt CB batter, with intermediate values (pH 5.83-5.90) seen for the 2% CB and 1% salt HB-¼CFAC batters. After 6 min, the pH of 1 and 2% salt HB-¼CFAC batters continuously decreased and showed no difference (P>0.05) from the CB batters, regardless of salt content, whereas the lowest pH (5.68-5.52) was seen for the 1% salt HB-¼CFAC batter from 15 min to the rest mincing (FIG. 7).

Unlike the HB-¼CFAC, the pH of CB batters remained constant in the range of 5.8±0.2 throughout the mixing, regardless of salt content. As a result, the CB batter pH was the same as the 2% salt HB-¼CFAC batter and significantly higher (P<0.05) than the 1% salt HB-¼CFAC batter after 15 min mincing (FIG. 7). It has been known that the pH of pre-rigor meat rapidly drops when the meat are ground or turned into batter.

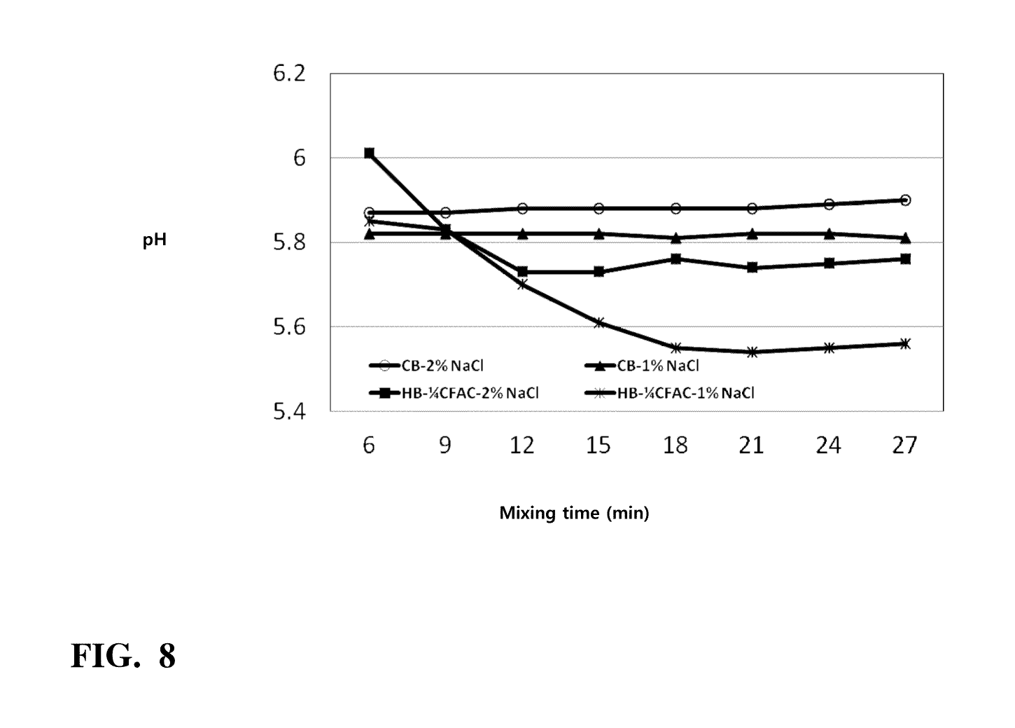

When meat batters were taken during mincing and stored at 4° C. overnight, the overall pattern of pH was as similar as that of the fresh batter except the 1% salt HB batter, resulting in additional reduction by 0.1-0.2 pH unit (FIG. 8). It appears that the grinding time of pre-rigor muscle for batter generation might affect the batter pH more than the storage of the batter for overnight. In our study, during the overnight storage at 5° C., glycolysis was presumed to occur more in 1% salt HB-¼CFAC batter than in 2% salt HB-¼CFAC batter.

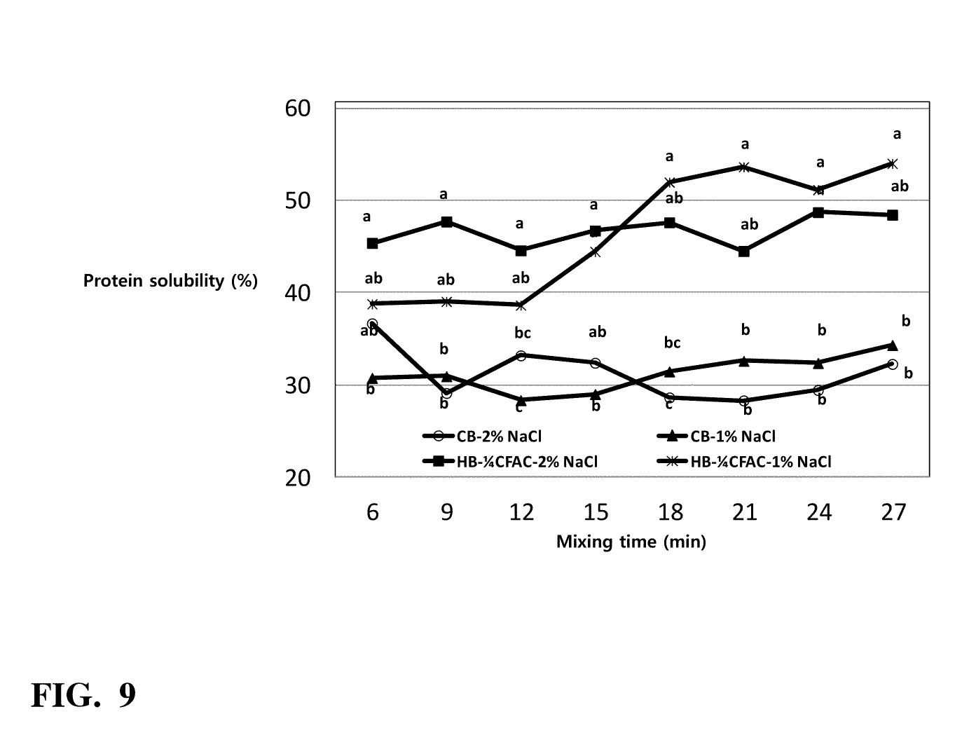

It has been known that proteins in pre-rigor muscle are extracted easier than post-rigor muscle. The solubilized proteins in HB-¼CFAC batters ranged from 44 to 54% during the entire mincing, except the 6-12 min batter in 1% salt, whereas those of CB controls did not exceed more than 37% (FIG. 9). Similarly, Bernthal et al. (1989) reported that the extractable protein value was 50 and 49% in pre-rigor homogenates in 1 and 2% salts, respectively, whereas that of post-rigor homogenate was 29%, regardless of the salt content.

The functional property of heat-induced gels are closely related with three dimensional gel-structure and influenced by various factors such as types of muscles, amount of connective tissues, pH, salt, and heating conditions. In scanning electron micrographs, the batter properties of structural integrity, fat droplet entrapment, and matrix complex with connective tissues were detected more clearly in 2% salt HB-¼CFAC batter at 6, 12, and 24 min than those of 2% salt CB batter. A similar pattern of results was observed in 1% salt HB-¼CFAC batter, whereas collapsed structure and fluffed appearance were seen in 1% salt CB batters at 12 and 24 min, respectively. These structural differences observed in SEM are related to the higher stress values seen in the HB-¼CFAC batters than the CB batters.

The fat particles in 2% salt HB-¼CFAC batters appeared to be sufficiently encapsulated with proteins at 6 min mincing, which became smaller in size as the chopping was continued, whereas the fat particles in 2% salt CB batters were small in size at 6 min mincing and became almost undetectable at 12 and 24 min mincing.

The technique of HB-¼CFAC for turkey fillets generated high quality raw turkey meats with high muscle pH. The implementation of cold mincing to the HB-¼CFAC fillets in 1% of salt produced high batter quality with more or equal amounts of protein extraction as compared to the cold-boned/traditionally-minced control fillets in 2% salt, indicating that salt content can be reduced by 50% without any loss of textural quality. After cooking, the stress and strain values of HB-¼CFAC gel containing 1% salt were same as those of chill-bond control containing 2% salt. Lastly, the HB-¼CFAC technique provides additional advantages such as rapid meat turn over and high quality meats for various other applications. Given the results of high quality raw meats and improved protein functionality, the combination of HB-¼CFAC and cold-mincing techniques appears to be effective on sodium reduction in processed meats with improved processing efficacy compared to the current chilling boning processing.

The order of execution or performance of the operations in the embodiments of the disclosure illustrated and described herein is not essential, unless otherwise specified. That is, the operations described herein may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Other aspects and features of the present disclosure may be obtained from a study of the drawings, the disclosure, and the appended claims. The methods illustrated within the disclosure may be practiced otherwise than as specifically described within the scope of the appended claims. It should also be noted that the steps and/or functions listed within the appended claims, notwithstanding the order of which steps and/or functions are listed therein, are not limited to any specific order of operation.

Although specific features of various embodiments within the disclosure may be shown in some drawings and not in others, this is for convenience only. In accordance with the principles of the disclosure, any feature of a drawing may be referenced and/or claimed in combination with any feature of any other drawing.

What is claimed is:

1. A method of preparing meat comprising the steps of:
separating a meat segment from a carcass when the carcass has a temperature within five degrees Celsius (5° C.) of live body temperature;
reducing the size of the meat segment into a plurality of meat segments;
crust-freezing the plurality of meat segments; and
combining the crust-frozen plurality of meat segments with water, ice, and salt, at a temperature within five degrees Celsius (5° C.) of freezing to form a batter.

2. The method, as in claim 1, wherein the temperature of the meat segment upon separation is no less than five degrees Celsius (5° C.) below the live body temperature.

3. The method, as in claim 1, wherein the salt present is in an amount that the batter is within zero point five percent (0.5%) to five percent (5%) sodium chloride by weight.

4. The method, as in claim 1, wherein the step of crust-freezing occurs at a temperature from minus five (−5° C.) to minus fifty (−50° C.) degrees Celsius.

5. The method, as in claim 1, wherein the amount of crust-frozen meat segments present in the batter is from twenty percent (20%) to ninety percent (90%) by weight.

6. The method, as in claim 4, wherein the step of crust-freezing is further defined as air-freezing.

7. The method, as in claim 6, wherein the step of air-freezing comprises a rate of air flow from zero point five meter per second (0.5 m/s) to six meters per second (6 m/s).

8. The method, as in claim 1, wherein the amount of water in the batter is from zero point one percent (0.1%) to four percent (4%) by weight.

9. The method, as in claim 1, wherein the amount of ice in the batter is within five percent (5%) of forty percent (40%) by weight.

10. The method, as in claim 1, wherein a protein functionality of hot boned meat segment is retained within the batter.

11. The method, as in claim 1, wherein the batter maintains a higher pH and lower R-value.

12. A batter formed from the method of claim 1.

13. A batter comprising meat, water, ice, and salt, wherein the batter is prepared by:
separating a meat segment from a carcass when the carcass has a temperature within five degrees Celsius (5° C.) of live body temperature;
reducing the size of the meat segment into a plurality of meat segments;
crust-freezing the plurality meat segments; and
combining the crust-frozen plurality of meat segments with water, ice, and salt, at a temperature within five degrees Celsius (5° C.) of freezing to form a batter.

14. The batter, as in claim 13, wherein the temperature of the meat segment upon separation is no less than 5 degrees Celsius (5° C.) below the live body temperature.

15. The batter, as in claim 13, wherein the salt is present in the batter in an amount that is from zero point five percent (0.5%) to five percent (5%) sodium chloride by weight.

16. The batter, as in claim 13, wherein the step of crust-freezing occurs at a temperature from minus five (−5° C.) to minus fifty (−50° C.) degrees Celsius.

17. The batter, as in claim 13, wherein the amount of crust-frozen meat segments present in the batter is within thirty percent (30%) of ninety percent (90%) by weight.

18. The batter, as in claim 16, wherein the step of crust-freezing is further defined as air-freezing.

19. The batter, as in claim 18, wherein the step of air-freezing comprises a rate of air flow from zero point one meter per second (0.1 m/s) to six meters per second (6 m/s).

20. The batter, as in claim 13, wherein the amount of water in the batter is within a tenth percent (0.1%) of four percent (4%) by weight.

21. The batter, as in claim 13, wherein the amount of ice in the batter is within five percent (5%) to forty percent (40%) by weight.
